(19) United States
(12) Patent Application Publication
(10) Pub. No.: US 2026/0215623 A1
(43) Pub. Date: Jul. 30, 2026

(54) STIR-FRYING PAN

(71) Applicant: Hiu Tung CHAU, Hong Kong (CN)

(72) Inventor: Hiu Tung CHAU, Hong Kong (CN)

(21) Appl. No.: 19/036,667

(22) Filed: Jan. 24, 2025

(51) Int. Cl. A47J 37/10

(52) U.S. Cl. CPC A47J 37/108

(57) ABSTRACT

A stir-frying pan, comprises a pan body, a handle, connected to the pan body, the pan body is equipped with a stirring component for assisting in stir-frying, which includes a roller and a sliding groove; the sliding groove is positioned at the bottom of the pan body; the roller is slidingly arranged within the sliding groove and move back and forth along the groove. By incorporating a sliding groove and a roller at the bottom of the pan body, users can easily and simply perform a series of operations such as pulling back, pushing out, lifting, and pulling back again the pan by the roller as a pivot point and repeat the actions above to realize continuous stir-frying operations which save effort and allow people to achieve the technique of flipping the pan for cooking dishes without any professional training.

### FIELD OF THE INVENTION

The present invention relates to the technical field of kitchenware, specifically to a stir-frying pan.

### BACKGROUND OF THE INVENTION

When cooking dishes, in order to make the dishes heat more evenly and let the seasonings be fully contacted with the dishes in the pan to avoid uneven seasoning and affect the final taste of the dishes, the chef will quickly flip the pot back and forth, which is called “flipping the pan” . . .

For a professional chef, mastering the technique of flipping the pan while stir-frying is a fundamental skill that requires a high level of expertise and strong arm and wrist to keep holding the pan in the air and stir-frying the dishes back and forth. After a period of operation, even an experienced chef feels soreness and pain in their arms. Anyone who has worked as a chef will surely understand such a bad experience.

For ordinary people or housewife without extensive professional training, mastering the technique of flipping the pan while stir-frying becomes even more challenging. Therefore, there is a need for a stir-frying pan that will save effort and be easy flipping and cooking without any professional training.

### SUMMARY OF THE INVENTION

The present invention provides a stir-frying pan to effectively solve the problems of existing technology.

The technical solution of the present invention is that:

A stir-frying pan, comprising,
a pan body,
a handle, connected to the pan body,
the pan body is equipped with a stirring component for assisting in stir-frying, which includes a roller and a sliding groove; the sliding groove is positioned at the bottom of the pan body; the roller is slidingly arranged within the sliding groove and move back and forth along the groove.

Furthermore, the pan body is divided into a front portion and a rear portion; the handle is arranged on the outer rim of the rear portion of the pan body; the rim at the front portion extends upward to form an anti-splash portion for prevent food from splattering while stir-frying; the height of the anti-splash portion is greater than that of the rear portion.

Furthermore, the anti-splash portion is a triangular shape, with both sides inclined inward to form a blocking section, and the central part forming a gathering section.

Furthermore, the anti-splash portion is a curved shape.

Furthermore, a storage space is provided in the handle where is near to the pan body; the storage space provides a storage cavity for placing the roller, and the storage cavity extends to the sliding groove at the bottom of the pan body.

Furthermore, the storage cavity is equipped with a roller lock for fixing the roller; a pivot shaft is arranged in the middle of the roller lock for connecting to the storage space; a block part for locking the roller is provided at one side of roller lock to contact with the roller, and a return spring is provided at the other side.

Furthermore, a push spring is arranged in the storage space; a fixed end connects with the wall of the storage space and a free end contacts with the roller.

Furthermore, the sliding groove extends a distance of two-third of the length of the pan bottom from the end of the pan.

The beneficial effects of the invention are as follows: by incorporating a sliding groove and a roller at the bottom of the pan body, users can easily and simply perform a series of operations such as pulling back, pushing out, lifting, and pulling back again the pan by the roller as a pivot point and repeat the actions above to realize continuous stir-frying operations which save effort and allow people to achieve the technique of flipping the pan for cooking dishes without any professional training.

### BRIEF DESCRIPTION OF THE DRAWINGS

FIG. 1 is a cross-sectional structural schematic diagram of the present invention.

FIG. 2 is a structural schematic diagram of the first embodiment of the present invention.

FIG. 3 is a structural schematic diagram of the second embodiment of the present invention.

FIG. 4 is a partially enlarged schematic diagram of the area marked “A” in FIG. 1.

FIG. 5 is a schematic diagram illustrating step 1 of the stir-frying pan operation of the present invention.

FIG. 6 is a schematic diagram illustrating step 2 of the stir-frying pan operation of the present invention.

FIG. 7 is a schematic diagram illustrating step 3 of the stir-frying pan operation of the present invention.

In the drawing: 1. Pan Body, 2. Handle, 3. Roller, 4. Sliding Groove, 5. Front Portion, 6. Rear Portion, 7. Anti-splash Portion, 8. Blocking Section, 9. Gathering Section, 10. Storage Space, 11. Storage Cavity, 12. Roller Lock, 13. Pivot Shaft, 14. Limit Block, 15. Return Spring, and 16. Push Spring.

### DESCRIPTION OF THE EMBODIMENTS

The following will provide a clear and complete description of the concepts, specific structures, and technical effects of the present invention, in combination with the embodiments and drawings, so as to fully understand the purpose, solutions, and effects of the present invention. It should be noted that, in the absence of conflict, the embodiments of the features in this application may be combined with each other.

It should be noted that, unless otherwise specified, when a feature is referred to as “fixed” or “connected” to another feature, it may be directly fixed or connected to the other feature, or indirectly fixed or connected to the other feature. Additionally, the terms of “up,” “down,” “left,” “right,” “top,” “bottom,” etc., used in the present invention only describe the relative positional relationships among the various components of the present invention in the accompanying drawings.

Further, unless defined otherwise, all technical and scientific terms used herein have the same meanings as commonly understood by one of ordinary skill in the art. The terms used in this specification are only for the purpose of describing specific embodiments and are not intended to limit the present invention. The term “and/or” used herein includes any combination of one or more of the associated items.

It should be understood that, although terms such as “first,” “second,” “third,” etc., may be used in the present disclosure to describe various components, these components are not limited to these terms. These terms are merely used to distinguish between components of the same type. For example, without departing from the scope of the present disclosure, a first component may also be referred to as a second component, and similarly, a second component may be referred to as a first component.

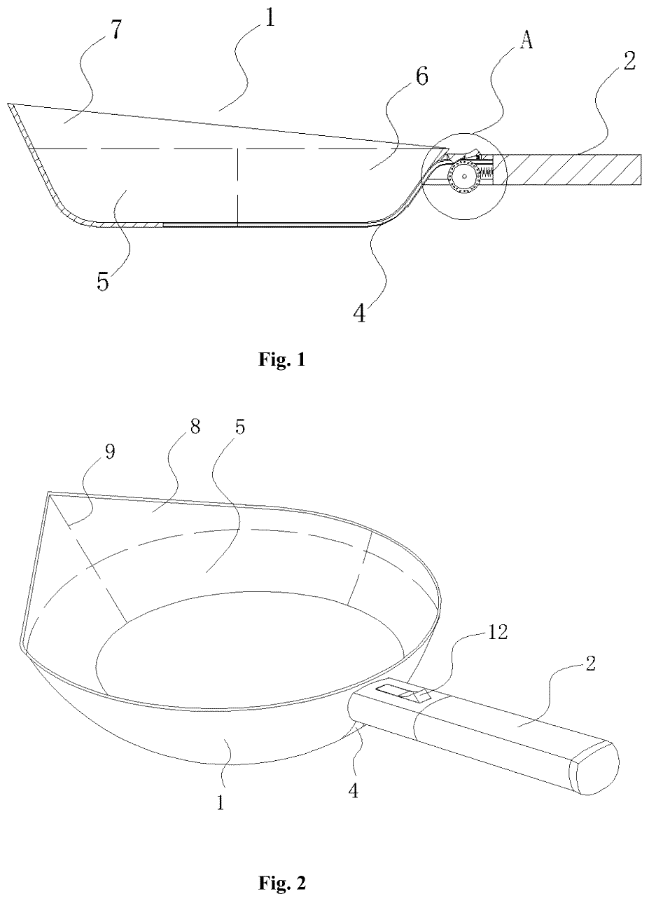

As shown in FIG. 1 to FIG. 7, the present invention provides a stir-frying pan which comprises a pan body 1, a handle 2, connected to the pan body 1, the pan body 1 is equipped with a stirring component for assisting in stir-frying. The stirring component includes a roller 3 and a sliding groove 4; the sliding groove 4 is positioned at the bottom of the pan body 1; the roller 3 is slidingly arranged within the sliding groove 4 and move back and forth along the groove 4. By incorporating the sliding groove 4 and the roller 3 at the bottom of the pan body 1, users can easily and simply perform a series of operations such as pulling back, pushing out, lifting, and pulling back again the pan by the roller 3 as a pivot point and repeat the actions above to realize continuous stir-frying operations which save effort and allow people to achieve the technique of flipping the pan for cooking dishes without any professional training.

As shown in FIG. 1, to prevent food from spilling out of the pan while flipping during stir-frying, the pan body 1 is divided into a front portion 5 and a rear portion 6; the handle 2 is arranged on the outer rim of the rear portion 6 of the pan body 1; the rim at the front portion 5 extends upward to form an anti-splash portion 7 for prevent food from splattering while stir-frying; the height of the anti-splash portion 7 is greater than that of the rear portion 6, therefore, the dishes are blocked by providing the anti-splash portion 7.

As shown in FIG. 2, it is the first embodiment of the present invention. To further prevent dishes from spilling out of the pan, the anti-splash portion 7 is a triangular shape, with both sides inclined inward to form a blocking section 8, and the central part forming a gathering section 9. The blocking section 8 on both sides can gather the food that is thrown forward and stir-fried to the gathering section 9 for collision and concentration, and then return to the pan body 1, thereby achieving the function of preventing splashing and enabling the food to be further colliding achieves the effect of even stir-frying.

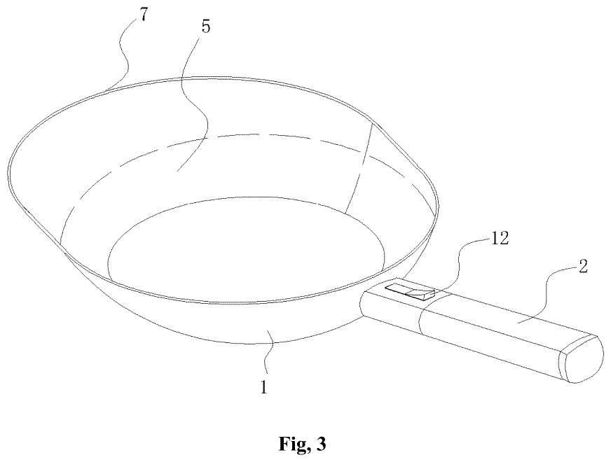

As shown in FIG. 3, it is the second embodiment of the present invention. o further prevent dishes from spilling out of the pan, the anti-splash 7 portion is a curved shape. Therefore, the curved anti-splash portion 7 allows the dishes to slide forward along the anti-splash portion 7 to be stir-fried and then return to the pot body 1.

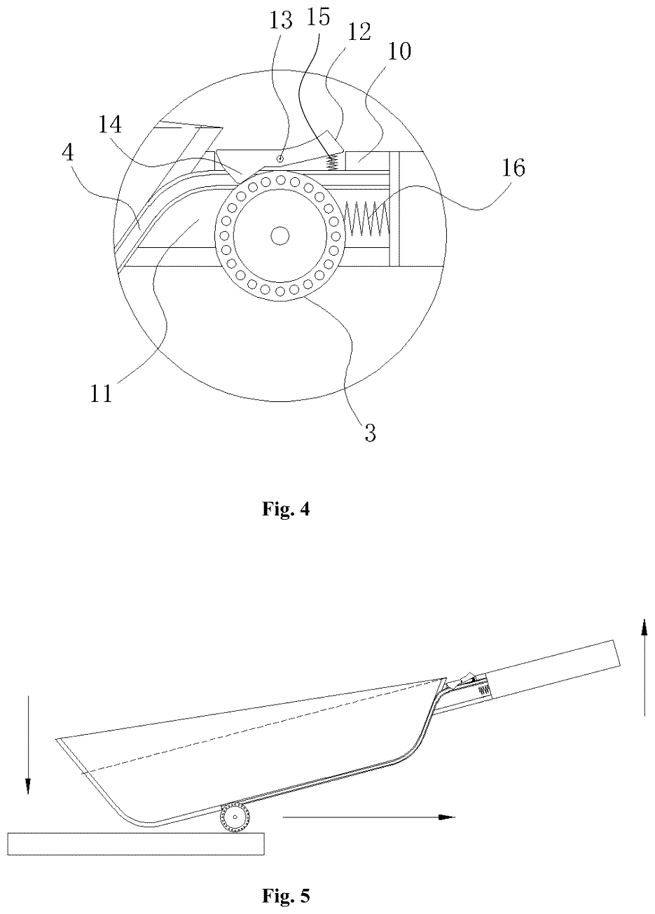

As shown in FIG. 1 and FIG. 4, a storage box is located near the pan body on the handle. The storage space 10 is provided in the handle 2 where is near to the pan body 1. The storage space 10 provides a storage cavity 11 for placing the roller 3, and the storage cavity 11 extends to the sliding groove 4 at the bottom of the pan body 1. Therefore, when the roller 3 is not in use, it can slide along the slide groove 4 into the storage cavity 11 of the storage space 10 for convenient storage.

As shown in FIG. 4, to prevent the roller 3 from sliding out when not in use, the storage cavity 11 is equipped with a roller lock 12 for fixing the roller 3. The pivot shaft 13 is arranged in the middle of the roller lock 12 for connecting to the storage space 10. The block part 14 for locking the roller 3 is provided at one side of roller lock 12 to contact with the roller 3, and a return spring 15 is provided at the other side. The roller 3 can be stopped by the block block 14 of the roller lock 12, so that the roller 3 can be fixed in the storage cavity 11; when the roller 3 should be in use, it is only necessary to press the roller lock 12 to make the block part 14. The roller 3 is thereby released to slide along the sliding groove 4 to the bottom of the pan.

As shown in FIG. 4, to facilitate the roller being quickly reaching the working position, the push spring 16 is arranged in the storage space 10. The fixed end connects with the wall of the storage space 10 and the free end contacts with the roller 3. When the roller 3 is not locked in the storage cavity 11, the roller 3 can be ejected by the push spring 16, so that the roller 3 can quickly slide to the bottom of the pot body 1.

As shown in FIG. 1, the sliding groove 4 extends a distance of two-third of the length of the pan bottom from the end of the pan body 1.

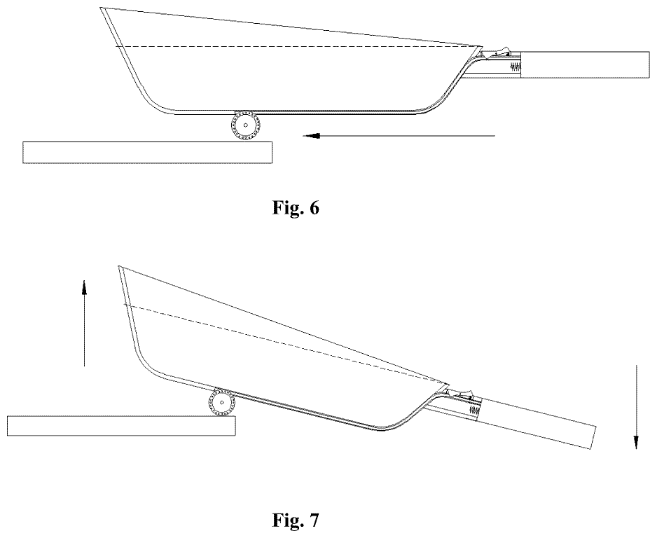

The steps for flipping the pan during stir-frying are as follows: First, press the limit switch to release the roller from the storage box, allowing it to slide along the sliding groove to the bottom of the pan body, serving as a pivot point. As shown in FIG. 5, pull the pan body back and tilt it to let the food slide towards the front end portion of the pan. Then, as illustrated in FIGS. 6 and 7, push the pan body forward while lifting it to raise the food. Immediately afterward, pull the pan body back to return the food to the pan, creating a continuous cycle to achieve the flipping action during stir-frying.

The procedure of stir-frying pan are as follows: first, press the roller lock 12 to release the roller 3 from the storage space 10 and it slides along the slide groove 4 to the bottom of the pan body 1 as a fulcrum for force. As shown in FIG. 5, the pan body 1 is pulled backward and tilted so that the dish slides to the front portion 5 of the pan body 1, and then push the pan body 1 forward as shown in FIG. 6 and FIG. 7, then continue to lift the pan body 1 to lift the dishes. As shown in FIG. 7, the pan body 1 is immediately pulled back to put the dish back into the pan body 1, thereby continuously performing the operation of stir-frying the pot.

The above descriptions are merely preferred embodiments of the present invention. The invention is not limited to the aforementioned implementations. As long as the same means achieve the technical effects of the invention any modifications, equivalent substitutions, or improvements made within the spirit and principles of this disclosure should be included within the scope of protection provided herein. All such variations fall within the protective scope of the invention. Within the protection scope, the technical solutions and/or implementations of the invention can undergo various modifications and changes.

1. A stir-frying pan, comprising,
a pan body,
a handle, connected to the pan body,
the pan body is equipped with a stirring component for assisting in stir-frying, which includes a roller and a sliding groove; the sliding groove is positioned at the bottom of the pan body; the roller is slidingly arranged within the sliding groove and move back and forth along the groove.

2. The stir-frying pan of claim 1, wherein the pan body is divided into a front portion and a rear portion; the handle is arranged on the outer rim of the rear portion of the pan body; the rim at the front portion extends upward to form an anti-splash portion for prevent food from splattering while stir-frying; the height of the anti-splash portion is greater than that of the rear portion.

3. The stir-frying pan of 2, wherein the anti-splash portion is a triangular shape, with both sides inclined inward to form a blocking section, and the central part forming a gathering section.

4. The stir-frying pan of claim 2, wherein the anti-splash portion is a curved shape.

5. The stir-frying pan of claim 1, wherein a storage space is provided in the handle where is near to the pan body; the storage space provides a storage cavity for placing the roller, and the storage cavity extends to the sliding groove at the bottom of the pan body.

6. The stir-frying pan of claim 1, wherein the storage space is equipped with a roller lock for fixing the roller; a pivot shaft is arranged in the middle of the roller lock for connecting to the storage space; a block part for locking the roller is provided at one side of roller lock to contact with the roller, and a return spring is provided at the other side.

7. The stir-frying pan of claim 5, wherein a push spring is arranged in the storage space; a fixed end connects with the wall of the storage space and a free end contacts with the roller.

8. The stir-frying pan of claim 1, wherein the sliding groove extends a distance of two-third of the length of the pan bottom from the end of the pan.
